(19) United States
(12) Patent Application Publication
(10) Pub. No.: US 2017/0347825 A1
(43) Pub. Date: Dec. 7, 2017

(54) CAPSULE, DEVICE AND METHOD FOR BREWING A BEVERAGE

(71) Applicant: Conopco, Inc., d/b/a UNILEVER, Englewood Cliffs, NJ (US)

(72) Inventor: Daniel Mark Walter, Northampton (GB)

(73) Assignee: Conopco, Inc., d/b/a UNILEVER, Englewood Cliffs, NJ (US)

(21) Appl. No.: 15/527,457

(22) PCT Filed: Oct. 22, 2015
(86) PCT No.: PCT/EP2015/074480

§ 371 Date: May 17, 2017

(30) Foreign Application Priority Data
Nov. 20, 2014 (EP) 14194061.9

(51) Int. Cl. A47J 31/06; A47J 31/40; A47J 31/60; A47J 31/44; A47J 31/46; B65D 85/804

(52) U.S. Cl. CPC A47J 31/0615; A47J 31/46; B65D 85/8043; A47J 31/60; A47J 31/0605; A47J 31/4492; A47J 31/407; A47J 31/0642; B65D 2203/00

(57) ABSTRACT

Disclosed is a capsule for use in a brewing device, the capsule comprising: a body part, which defines a cavity containing infusible beverage material; and a lid which is attached to the body part and which closes the cavity, wherein the lid comprises lines of weakness which define an opening region having an opening force of from 9.0 to 50 N.

### FIELD OF THE INVENTION

The present invention relates to capsules, methods and devices for preparing beverages. In particular, the invention relates to capsules for preparation of infused beverages that are brewed in a device having an infusion chamber.

### BACKGROUND OF THE INVENTION

Beverages such as tea and coffee are usually prepared in the home using ground coffee, tea bags or loose-leaf tea. However, the long brewing time and mess after brewing are inconvenient.

Devices for automatically brewing beverages are known. In particular, automatic capsule-based brewing devices have been developed. For coffee beverages the capsule itself typically functions as the brewing chamber. The volume of the capsule is normally less than that of the final beverage, so it is necessary for the brewing water to flow through the capsule. This is achieved by having a filter in the capsule so that the brewed beverage can be dispensed whilst the beverage material is retained, and is disposed of together with the capsule.

For beverages made from particulate infusible material that swells during brewing, devices have been developed wherein the capsule itself is not the brew chamber. For example, WO 2007/042485 A discloses a device for preparing an infused beverage, having an infusion container for containing liquid. A cartridge containing tea leaves is introduced into a cavity in the device. The bottom part of the cartridge comprises a liquid-permeable filter.

A rather recent development is that of capsule-based brewing devices with an infusion chamber and wherein the capsules are not necessarily required to comprise a filter. In particular, EP 2 781 174 A discloses a capsule for use in a brewing device, the capsule comprising: a body part, which defines a cavity, a lid which is attached to the body part and which closes the cavity, the lid having lines of weakness which define an opening region having an area of from 75 mm² to 300 mm²; and tea material enclosed within the cavity, wherein at least 75 percent by weight of the tea material particles have a size of from 2 to 10 mm. A method of preparing a tea-based beverage in a brewing device using the capsule is also provided. In one embodiment it is described that openings are made in the capsule with both a static opening member and a needle.

Whilst the capsule, device and method disclosed in EP 2 781 174 A present significant improvements over prior capsule-based systems, the present inventors have recognized that there is a need to provide further improved systems. In particular the inventors have recognized a need to provide capsules that are more robust in terms of resistance to transport, ability to be simultaneously pierced and opened, and/or ability to be placed in a brewing device in a number of different orientations whilst retaining functionality.

### SUMMARY OF THE INVENTION

In a first aspect, the present invention is directed to a capsule for use in a brewing device, the capsule comprising:
a body part, which defines a cavity containing infusible beverage material; and
a lid which is attached to the body part and which closes the cavity, wherein the lid comprises lines of weakness which define an opening region having an opening force of from 9.0 to 50 N.

The present inventors have found that by providing an opening region with an opening force of from 9.0 to 50 N, the opening region is on the one hand capable of being opened along the lines of weakness from contact by a blunt member, whilst on the other hand allowing the lines of weakness to remain unbroken when a needle-like member is pressed into the opening region. Thus if the capsule is placed in a device which employs a needle-like member for introducing liquid to the capsule, the capsule will still function even if it is placed in the device in an orientation wherein the opening region is penetrated by the needle. In such a situation it is advantageous that the opening region does not fully open when the needle is inserted such that liquid cannot easily exit the capsule around the needle instead of creating the desired flow pattern and/or pressure within the capsule. An additional or alternative advantage of this opening force range is the ability of the lines of weakness to remain intact throughout transport whilst still being easily opened by a device in use.

To provide further improved robustness to the capsule it is preferred that the opening force is at least 9.4 N, more preferably at least 9.7 N, even more preferably at least 10.0 N, and most preferably at least 10.5 N. To ensure that the opening region can be easily opened by a device it is preferred that the opening force is no greater than 30 N, more preferably no greater than 25 N, even more preferably no greater than 20 N, and most preferably no greater than 17 N.

The opening region is preferably large enough to allow infusible beverage material to exit the opened opening region and enter a brew chamber, thus it is preferred that the opening region has an area of at least 75 mm², more preferably at least 100 mm². Additionally or alternatively the opening region need not be too large especially wherein the capsule is not required to collect spent infusible material after brewing. It is preferred that the opening region has an area no greater than 400 mm², more preferably no greater than 300 mm², and most preferably no greater than 250 mm².

The capsule of the present invention is particularly suitable for use with tea material and especially tea material which has particle sizes which are adapted for brewing in an infusion chamber. Thus it is preferred that the infusible beverage material comprises tea material particles, more preferably wherein at least 75%, even more preferably 90 to 100% by weight of the tea material particles have a size from 2 to 10 mm, most preferably 3 to 7 mm.

In a preferred embodiment the lines of weakness partially surround the opening region so that on opening the opening region of the lid forms a flap, which may, for example, help to direct liquid and tea material out of the capsule and through the opening. Especially preferred is that the lines of weakness partially surround the opening region so that on opening the opening region of the lid forms a flap directed into the capsule body.

A convenient way of forming the lines of weakness is with perforations in the lid (although alternatives, such as scoring, may be used alone or in combination with perforations). To ensure that the opening region can be opened easily by a device, it is preferred that the cut:tie ratio of the perforations is greater than 1:1, more preferably at least 1.5:1 and most preferably at least 2:1. In order that the opening region has the desired opening force, it is preferred that the cut:tie ratio of the perforations is no greater than 5:1, more preferably no greater than 4:1 and most preferably no greater than 3:1.

To provide the desired opening force, as well as the configuration of the lines of weakness, the lid material may also be varied. It is preferred that the lid comprises or is a thin film formed from metallic foil or a laminated foil, most preferably a laminate of aluminium foil and polyethylene. Alternative thin films may also be used, for example plastic films that do not comprise a metallic layer. The lid preferably is a film with a total thickness of from 40 to 200 microns, more preferably 50 to 150 microns and most preferably 60 to 120 microns. Especially preferred is a thin film of aluminium foil and polyethylene (especially HDPE) laminate wherein the aluminium layer has a thickness of from 20 to 60 microns and the polyethylene layer has a thickness of from 20 to 60 microns. Most preferred is a thin film of aluminium foil and polyethylene laminate with a total thickness of about 80 microns, wherein each layer has a thickness of about 40 microns.

As stated above, a particular advantage of the capsule of the invention is that it may still function in a variety of orientations in a device. To further aid this property, it is preferred that the lid comprises a plurality of opening regions arranged symmetrically around the centre of the lid. In particular the lid may comprise n opening regions arranged symmetrically around the centre of the lid and the capsule is shaped to direct alignment of the capsule in the brewing device in any one of n fixed orientations, where n is an integer greater than 1. More preferably n is from 2 to 6, more preferably still 2 to 4, most preferably n is 2.

In a further aspect the present invention provides a brewing device containing a capsule according to any embodiment of the first aspect, the device comprising:
an infusion chamber;
a liquid supply line terminating in a needle mounted on a yoke;
an opening member mounted on the yoke;
a capsule holder for receiving the capsule;
a drive motor for driving relative movement of the yoke and capsule holder to allow the opening member to force open the opening region of the capsule lid and the needle to puncture the lid; and
a pump for introducing liquid through the needle and into the cavity of the capsule so that infusible material and liquid can mix and flow through the opening region into the infusion chamber.

In a still further aspect the present invention provides a method of preparing a brewed beverage from a capsule according to any embodiment of the first aspect, the method comprising:

(a) locating the capsule in a capsule holder of a brewing device;
(b) forcing open the opening region of the capsule lid with an opening member of the device;
(c) introducing liquid through a needle of the device into the cavity of the capsule so that infusible material and liquid mix and flow through the opening region into an infusion chamber of the device.

The capsule is particularly suitable for devices and methods wherein the needle and opening member are arranged so that the needle enters a region of the capsule lid outside of the opening region opened by the opening member, especially wherein the region of the lid entered by the needle is a further opening region defined by lines of weakness.

The capsule of the present invention may function even without requiring a filter in the capsule. Thus the capsule is especially suitable for devices and methods wherein the capsule holder comprises a filter and an openable and closable passage, wherein the passage is openable to allow brewed beverage to flow from the infusion chamber, through the filter and out through the passage.

All aspects of the present invention are particularly suitable for brewing tea-based beverages.

All other aspects of the present invention will more readily become apparent upon considering the detailed description which follows.

### DETAILED DESCRIPTION

As used herein the term “beverage” refers to a substantially aqueous drinkable composition suitable for human consumption. Preferably the beverage comprises at least 85 percent water by weight of the beverage, more preferably at least 90 percent and most preferably from 95 to 99.9 percent. The term “infusible beverage material” refers to tea plant material, herb plant material, fruit pieces and/or flower material (e.g. petals), which when steeped or soaked in an aqueous liquid release certain soluble substances into the liquid, e.g. flavour and/or aroma molecules. The term ‘tea’ refers to leaf and/or stem material from Camellia sinensis var. sinensis or Camellia sinensis var. assamica. It also includes rooibos obtained from Aspalathus linearis. ‘Tea’ is also intended to include the product of blending two or more of any of these teas. The tea material may be substantially fermented i.e. black tea, semi-fermented i.e. oolong tea, or substantially unfermented i.e. green tea. The term “herb plant material” refers to material which is commonly used as a precursor for herbal infusions. Preferably the herb plant material is selected from chamomile, cinnamon, elderflower, ginger, hibiscus, jasmine, lavender, lemongrass, mint, rosehip, vanilla and verbena. The tea material may additionally comprise fruit pieces (e.g. apple, blackcurrant, mango, peach, pineapple, raspberry, strawberry etc). The tea material can be flavoured and/or spiced, e.g. with bergamot, citrus peel and the like. The infusible beverage material is preferably material other than coffee material. Preferably the infusible beverage material is dried and has a moisture content of less than 30 wt percent, more preferably less than 20 wt percent and most preferably from 0.1 to 10 wt percent.

The beverage preferably comprises at least 0.01 percent by weight tea solids. More preferably the beverage comprises from 0.04 to 3 percent, even more preferably from 0.06 to 2 percent, most preferably from 0.1 to 1 percent by weight tea solids.

The term “particle size” refers to the longest length of a particle measurable in any dimension.

The “opening force” of an opening region refers to the maximum (peak) force required to pass the flat circular face of a cylindrical probe of 5 mm diameter through the centre of the opening region at a temperature of 25° C., with the probe travelling at 300 mm/min in the direction perpendicular to the face of the lid.

The term ‘brewing’ refers to the addition of a liquid, particularly hot water, to an infusible beverage material thereby to form a beverage. Brewing may be carried out at any temperature, but preferably in the range of 80 to 95 degrees centigrade

The term “infusion chamber” means a vessel in which infusion of infusible beverage material takes place, and which is large enough both to allow the beverage material to move around in the liquid during infusion, and also to contain a substantial part, at least 50 percent of the volume of the final beverage. The term “infusion chamber” therefore does not refer to capsules inside which brewing takes place (as is typically the case in coffee machines).

The term “relative movement” of two objects refers to moving either or both of the objects such that their position relative to each other is changed.

The term “capsule” refers to a rigid or semi-rigid container in which infusible beverage material is or may be packaged, for example a capsule, cartridge, pod, or the like.

The present invention will now be described with reference to the figures, wherein:

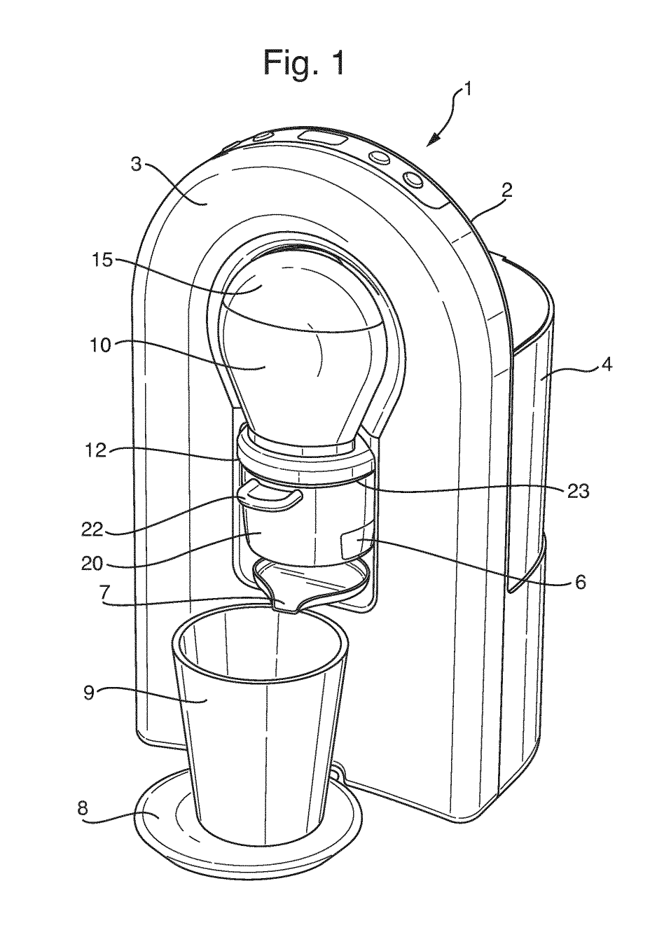

FIG. 1 shows a brewing device according to an embodiment of the invention.

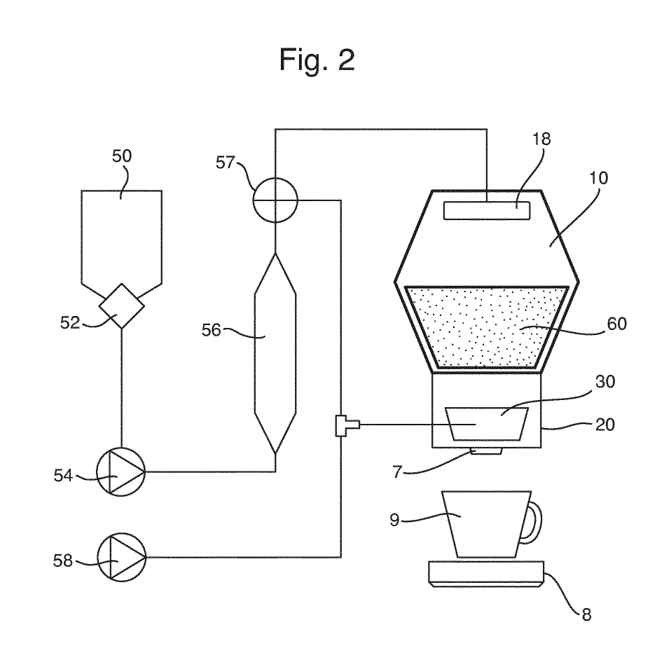

FIG. 2 is a schematic diagram showing the main functional components of the device of FIG. 1.

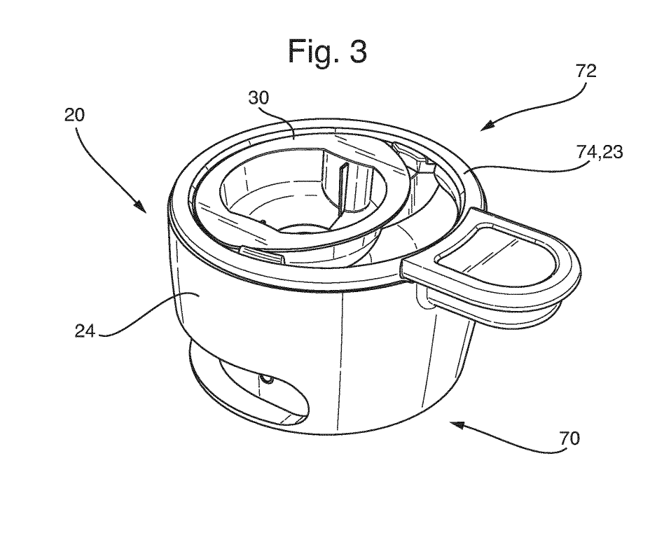

FIG. 3 shows an embodiment of a capsule holder for use in the present invention and containing a capsule.

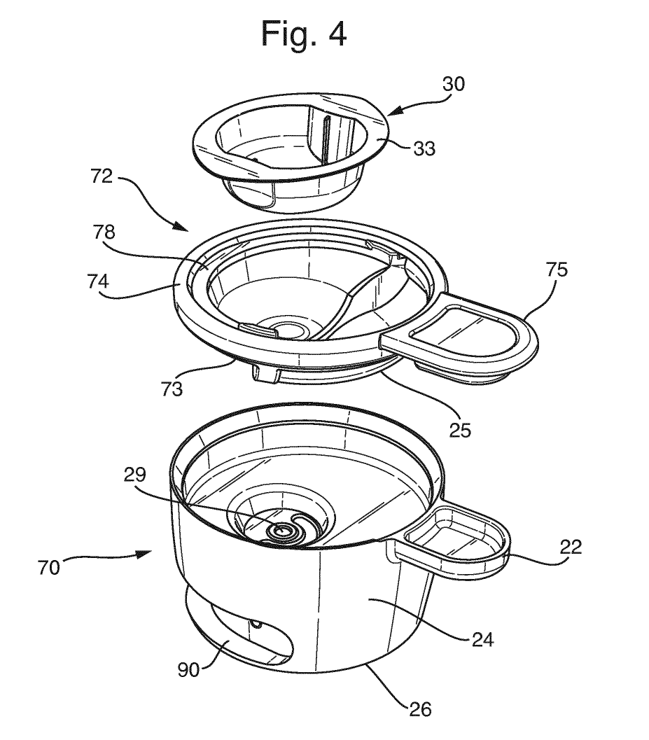

FIG. 4 shows the capsule holder of FIG. 3 in exploded view.

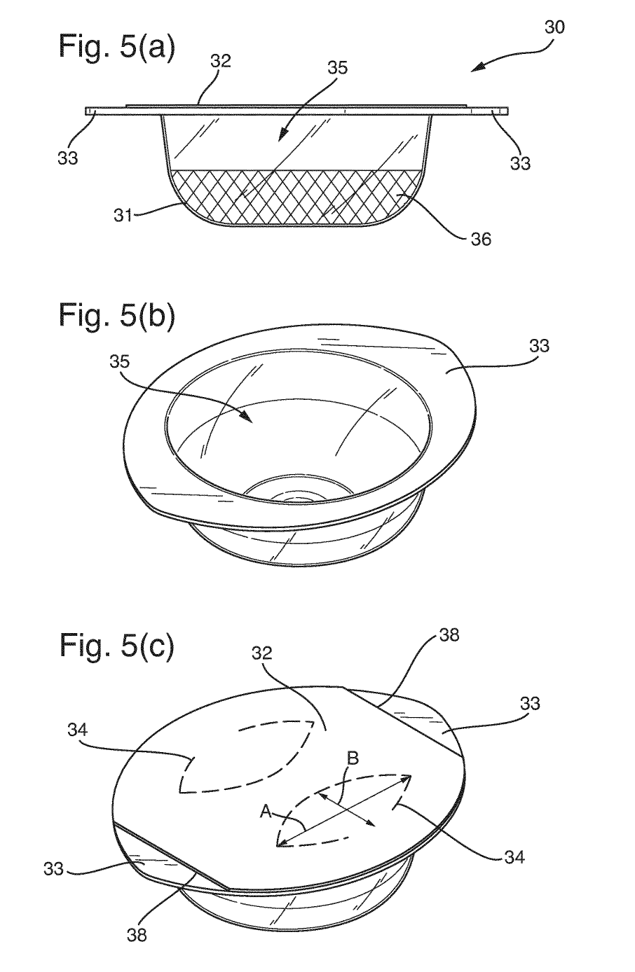

FIG. 5 shows (a) a side view of a capsule according to an embodiment of the invention, (b) a perspective view of the capsule without a lid and (c) with a lid.

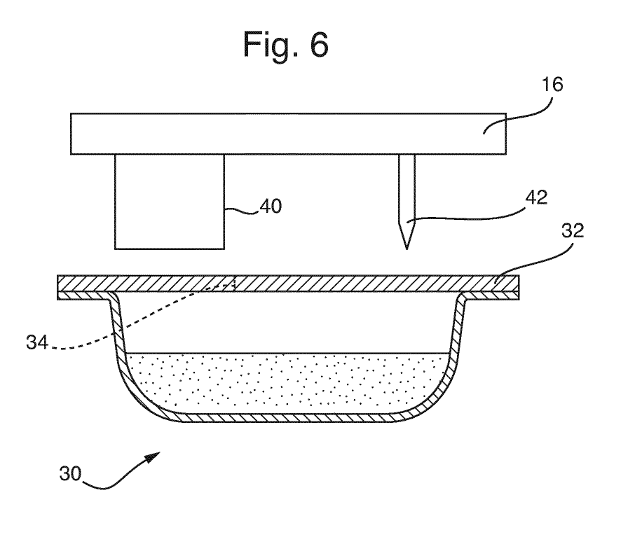

FIG. 6 shows a yoke comprising an opening member and needle in position to open the lid of a capsule according to an embodiment of the invention.

Referring now to FIG. 1, one non-limiting embodiment of a brewing device (1) is shown which has a casing (2) with a front side (3) and a rear side (4). An infusion chamber (10) and a capsule holder (20) are located at the front side of the device. The infusion chamber (10) has a bottom rim (12) which defines an opening in its lower side. The infusion chamber may have an opening in its top side which is covered with a removable lid (15), or it may be constructed as a vessel without an opening in its top side. The capsule holder (20) is designed to receive a capsule (not shown in FIG. 1). The holder (20) is located in a support (6) and preferably has a handle (22). The capsule holder is preferably substantially circular when viewed from above, which provides for easy cleaning since there are no corners in which tea leaves could become trapped.

In FIG. 1, the capsule holder (20) is shown in position for brewing, i.e. so that the upper rim (23) of the capsule holder is in water-tight contact with the bottom rim (12) of the infusion chamber (10). The infusion chamber (10) is supported and held in place by a manifold (not shown). A water reservoir, heater, and pump (not shown in FIG. 1) are located inside the rear (4) of the casing. At the bottom of the front side (3) of the casing there is a tray (8) on which a cup (9) is placed when the beverage is dispensed. A dispensing spout (7) is positioned beneath the capsule holder.

FIG. 2 is a schematic diagram showing the main functional components of the device. Water from a reservoir (50) is fed to the infusion chamber (10) via a water filter (52), a water pump (54), a heater (56) and a valve (57). The heater is preferably a flow-though heater. The valve (57) controls the route the water takes between the heater (56) and the infusion chamber (10). For example, the water may firstly be pumped to the infusion chamber (10) via the capsule (30) in order to brew a beverage (60). Subsequently, the valve (57) can re-direct the water such that it enters the infusion chamber (10) via a rinse head (18) in order to rinse and/or clean the infusion chamber (10). There may also be an air pump (58) which can pump air to the infusion chamber (10), for example via the capsule (30) which is located in the capsule holder (20), or via the capsule holder itself. The spout (7), cup (9) and tray (8) are located beneath the capsule holder (20).

The capsule holder (20) is preferably removable from the support (6) so that a capsule can be easily inserted, and also for ease of cleaning. FIGS. 3 and 4 show one embodiment of a capsule holder removed from the device. The capsule holder (20) has a sidewall (24) with an upper rim (23) and a base (26). The sidewall (24) is preferably circular when viewed from above. A filter (25) is located inside the capsule holder. The capsule (30) does not cover the whole of the area inside the upper rim of the capsule holder, so that there is a route for the brewed beverage to pass from the infusion chamber to the filter. Beneath the filter (25) is a passage (29) through which the beverage flows during dispensing and which is closed by a drain valve (not shown) during brewing. The filter preferably consists of a fine mesh made, for example, of stainless steel, nylon, polyester or PTFE. The mesh size must be sufficiently small to catch small pieces of infusible beverage material but large enough to ensure that draining is not too slow. Preferably, the mesh size is from 100 to 500 microns, more preferably 150 to 300 microns.

In the embodiment shown, the capsule holder (20) consists of two separable parts, a receptacle (70) and a strainer (72). The receptacle (70) comprises the sidewall (24), base (26), passage (29) and handle (22) of the holder (20). The strainer (72) has a base (73), a rim (74) and a handle (75). One or more protrusions (78), such as a shelf on the inside of the rim (74), support the capsule (30) and hold it in place above the base (73). At least part of the base (73) is made up of the filter (25). In the preferred embodiment shown, the part of the base (73) which is located underneath the capsule is solid whilst the rest of the base consists of the filter. The solid part may also serve to support the capsule.

As shown in FIG. 3, in use the strainer (72) rests on the receptacle (70) and is supported by the sidewall (24). The rim (74) of the strainer forms the upper rim (23) of the capsule holder (20). The strainer (72) covers the whole of the top of the receptacle (70), so that liquid cannot pass between the rim (74) of the strainer and the sidewall (24) of the receptacle, and hence can only enter the receptacle (70) by passing through the filter (25).

This embodiment has the advantage that the strainer and receptacle can be easily separated for cleaning. Moreover, in order to empty out spent infusible material from the capsule holder, it is only necessary to remove the strainer and tip the spent leaves out from it.

The capsule (30) shown in FIGS. 3 and 4 has a flange (33) which corresponds to the shape of the shelf (78) of the strainer, so that the flange (33) rests on the shelf along substantially all of one side of the capsule, and thus is supported by it. The flange has two-fold rotational symmetry and so can be supported by the shelf in any one of two orientations. The width of the shelf preferably matches the width of the flange, and is preferably at least 3 mm wide.

FIG. 5(a) shows a side view of a capsule (30). The capsule comprises a body part (31) and a lid (32). The body part (31) defines a cavity (35) in which the infusible beverage material (36) is placed. The lid (32) is attached to the body part (31) so as to enclose the infusible material (36) within the capsule. The functionality required of the capsule is significantly reduced compared to conventional capsules, because the capsule does not contain a filter. The brewing liquid does not need to enter through one side and exit through the other, so there is no need to puncture or otherwise make an opening in the body part of the capsule. Thus the construction of the capsule is greatly simplified. Thus the body part is a single, impermeable piece and does not contain any means (for example a filter, or an openable or weakened area) for allowing liquid to enter or exit the capsule through the body part. The body part is preferably made from plastic or aluminium. It may be formed for example by injection moulding or by thermoforming.

The cavity (35) is preferably generally circular in cross-section, when viewed from above, as shown in FIG. 5(b). This shape is convenient from the point of view of manufacture and also for filling infusible material into the capsule. It also facilitates release of the infusible material from the capsule during brewing, since there are no corners or other areas where the infusible beverage material could become trapped. “Generally circular” does not require that the cavity has an exactly circular cross-section; thus for example it could have small indents, provided that there are no narrow recesses in which infusible beverage material could become trapped.

The body part preferably comprises a flange (33), and the lid is preferably attached to the flange, e.g. by heat-sealing, thereby enclosing the infusible material. In order to provide sufficient area to attach the lid securely, the flange is preferably at least 3 mm wide. The flange (33) preferably also serves to support the capsule in the capsule holder by resting on the protrusions (78) on the inside the capsule holder, described above. Thus the flange is preferably shaped and sized to match its intended location in the capsule holder and in particular is shaped to direct alignment of the capsule in the brewing device in any one of two orientations.

Since the capsule only needs to be large enough to contain a single serving of the infusible beverage material it can be much smaller than known capsules. Thus the internal volume of the capsule (i.e. the volume of the cavity) is preferably from 10 to 24 cm³, more preferably 12 to 19 cm³, most preferably from 14 to 18 cm³. Moreover, the capsule only needs to be strong enough to support dry infusible material, and not wet spent material. Thus the body part of the capsule can also have relatively thin walls.

In another preferred embodiment, the capsule is only partially filled with the infusible beverage material. If the capsule contained a high proportion of infusible material then the material which swells during wetting could become jammed in the capsule and not be able to flow out of the capsule. Additionally some headspace within the capsule helps when forming a flap, as discussed below. Thus, preferably the capsule is filled with from 25 to 60 vol % of infusible beverage material. This relates to the natural settled volume of the capsule that is filled with infusible beverage material before any water is added and is uncompressed. For example the fill level obtained after shaking the capsule so the infusible material moves around freely within the capsule and then settles under its own weight. For example, a cylindrical capsule with the lower half filled with dry tea and the upper half vacant would comprise 50 vol % of dry tea material.

The reduced capsule size means that the amount of material (e.g. plastic) needed to make the capsule is significantly reduced. This has environmental and cost advantages. Furthermore, in some embodiments the capsule body part can be more easily recycled because it is made of a single material, unlike typical capsules having a filter. A small capsule also has the advantage of taking up less space during transport and during storage, for example in a consumer's cupboard.

The cavity must not be so shallow that infusible beverage material bounces out of it during filling. Thus the depth of the cavity is preferably at least 10 mm, more preferably at least 13 mm. On the other hand, the cavity must not be so deep that it is difficult to remove the infusible material from the capsule at the start of brewing. Thus the depth of the cavity is preferably at most 20 mm, more preferably at most 18 mm. It is easier to remove the infusible material from a cavity with a depth in the upper part of this range when the volume of the cavity is also towards the upper end of its range (i.e. when the cavity is not both deep and narrow).

The diameter of the cavity is preferably from 30 to 45 mm. The lid, which overlaps with or covers the flange as well as covering the cavity, is therefore preferably from about 45 to 60 mm in diameter, more preferably 47 to 58 mm. The lid is preferably shaped to generally match the shape of the flange.

The lid, typically on the uppermost face of the capsule, is preferably made of a thin film, more preferably metallic foil or a laminated foil, most preferably a laminate of aluminium foil and polyethylene as described above.

The lid has lines of weakness, such as perforations or scores in order to facilitate opening the capsule to release the infusible material. The lines of weakness preferably define an opening region on the capsule lid which has an area of from 75 mm² to 300 mm², more preferably from 100 mm² to 250 mm². The area of the opening region refers to the area of the opening which is created when the capsule is opened in the brewing device.

In one embodiment, the lines of weakness surround the opening region, so that the whole part of the lid inside the lines of weakness can be removed to form the opening. However, in a preferred embodiment the lines of weakness only partially surround the opening region: for example, the lines of weakness may constitute three sides of a square, In this way during the opening, the lid is torn or cut along the lines of weakness, leaving a section of the opening region which remains attached to the rest of the lid (i.e. the fourth side of the square) to form a flap, which opens inwardly into the capsule.

In a particularly preferred embodiment, the lid (32) has a line of weakness (34) in the form of a curve, with sections which extend backwards from the ends of the curve, as shown in FIG. 5(c). This configuration produces a well-defined opening when the lid is pushed against an opening member (described below), which allows the infusible material to be released from the capsule. The part of the lid between the ends of the sections which extend backwards is not perforated or scored, and forms a hinge on opening. The opening region forms a flap which opens inwardly into the capsule. The resulting opening is approximately elliptical in shape, with a short axis (marked B in FIG. 5(c)) aligned along the radial direction of the capsule and a long axis (marked A in FIG. 5(c)) perpendicular to it. The length of the long axis is defined by the distance between the end points of the curved line of weakness, and the short axis is defined by the distance between the point of the curve closest to the centre of the lid and the line of the hinge. Preferably the short axis has length of from 8 to 18 mm, more preferably from 10 to 15 mm. Preferably the long axis has a length of from 25 to 35 mm, more preferably from 28 to 32 mm. The flap should be large enough to allow large particles of infusible material to be released, but should not be too big, because that would increase the chance of particles becoming trapped behind it.

Preferably the lines of weakness are perforations as described above.

Preferably the capsule lid has two identical sets of lines of weakness (as shown in FIG. 5(c)) so that the capsule can be placed in the capsule holder in either of the two possible orientations and still allow the opening region to be opened by the opening member.

Preferably the capsules are provided to the consumer in air-tight secondary packaging, for example as multipacks containing a plurality of capsules (e.g. ten). The multipacks may contain packages of a single type, or a mixture of packages containing different types of infusible material (e.g. green tea, black tea, herbal tea). Having a perforated lid has a further advantage in that some of the aroma is released from the infusible material inside the capsule into the space inside the secondary packaging. Thus the consumer obtains the aroma of beverage material on opening the secondary pack.

In a preferred embodiment, the cavity has a generally circular cross-section, but the flange (33) is elongated, for example it is generally elliptical in shape, or is defined by two intersecting circular arcs. “Generally elliptical” does not require that the flange is exactly elliptical. The flange has a radius of curvature that is similar to the radius of the inside of the sidewall (24) of the capsule holder, so that the shape of the flange generally corresponds to the shelf (78) as described above. Nonetheless, small variations from an elliptical shape can be accommodated whilst there is still sufficient overlap between the flange and the shelf to support the capsule. Some examples of generally elliptical shapes are shown, for example, in EP 2781 174 A, the disclosure of which is hereby incorporated by reference in its entirety. The ratio of the longest diameter of the flange to the shortest diameter of the flange is preferably from 1.2:1 to 1.5:1. A minimum ratio of 1.2:1 gives plenty of space for the brewed beverage to pass by the capsule, and a maximum ratio of 1.5:1 means that the capsule can be large enough to contain sufficient infusible material, without requiring an excessively large capsule holder. Most preferably the flange of the capsule is defined by two intersecting circular arcs each having a radius of curvature (R) which is substantially half of the internal diameter (D) of the capsule holder, as described in EP 2 781 174 A.

In the embodiment shown, the shape of the lid (32) is preferably also defined by two intersecting circular arcs, but with truncated ends (38), as shown in FIG. 5(c). The length of the lid between the two truncated ends is preferably from 47 to 58 mm, and the maximum width of the lid is preferably from 45 to 50 mm. The capsule shown is symmetrical (in particular it has 180° rotational symmetry about a vertical axis). There are preferably two sets of perforations in the lid, arranged symmetrically, as shown in FIG. 5(c), so that the capsule can be placed in the capsule holder in either of two orientations.

In a preferred embodiment, the body part of the capsule is transparent, so that the infusible material inside the capsule is visible. This is attractive to the consumer, and also has the advantage that the contents can be inspected for quality control purposes after filling using optical means, rather than, for example, by weight.

In use, the device (1) functions as follows. With the capsule holder (20) in its lowered position, the user removes the capsule holder (20) from the support (6), or in the embodiment of the capsule holder shown in FIGS. 3 and 4, the user may just remove the strainer (72) from the receptacle (70). A capsule (30) containing infusible material (36) is placed into the capsule holder so that it rests on the protrusions (78) on the inside of the sidewall and/or the base of the capsule holder. The protrusions support the capsule and preferably also locate it in the correct position.

The capsule holder (20) is then replaced on the support (6). Next the user raises the support (6), for example by pressing a button on the device which activates an actuator. The actuator comprises a drive motor (not shown) which drives relative movement of the capsule holder and infusion chamber until they are connected. In one embodiment the drive motor drives travel of the capsule holder vertically upwards until it connects with the infusion chamber, and forms a water-tight seal. In an alternative embodiment, the motor drives travel of the infusion chamber down towards the capsule holder. In a still further embodiment the drive motor drives travel of the holder upwards and the chamber downwards such that they connect in a position intermediate between their positions in the open state.

In the context of the present invention, ‘connecting the upper rim of the capsule holder to the bottom rim of the infusion chamber’ and ‘the upper rim is connected to the bottom rim of the infusion chamber’ should be understood to mean that upper rim (23) of the capsule holder (20) and the bottom rim (12) of the infusion chamber (10) form a water-tight contact, so that the capsule holder and infusion chamber form a vessel in which the brewing liquid can be held while brewing takes place. The capsule holder and infusion chamber may be connected by means of an intermediate member such as a gasket (for example a ring made of rubber or other compliant material located on the upper rim of the capsule holder and/or the bottom rim of the infusion chamber) in order to provide a good seal. The infusion chamber and the capsule holder form a space for brewing when connected. Preferably the volume of the space for brewing is at least 75%, most preferably from 90% to 300% of the volume of the final beverage.

The device may have means for recognizing a capsule and/or reading information from a code associated with the capsule or the capsule holder.

Optionally, the device may also have means for allowing the user to adjust the parameters of the brewing operation, such as the brewing time, the receptacle size etc. The means may suitably consist of buttons or other inputs on the device, together with a control system.

The lid of the capsule is opened automatically by the device (1) after the capsule (30) has been inserted into the capsule holder (20) in order to release the infusible material. Preferably the lid (32) is opened as the upper rim (23) of the capsule holder is connected to the bottom rim (12) of the infusion chamber. Preferably, two openings are made in the lid, one to introduce liquid into the capsule and the other to release liquid and tea material into the infusion chamber. However, because the capsule does not have a filter, there is no need to puncture or otherwise make an opening in the base of the capsule. In particular it is preferred that the capsule according to the invention when in use in a device it is adapted for, brewing liquid does not enter through the base of the capsule.

In a preferred embodiment, shown in FIG. 6, the lid (32) is opened by pushing it against a yoke (16) comprising one or more opening members (40) when the capsule holder (20) and yoke travel towards each other. The yoke (16) is preferably attached to the manifold in the region of the bottom rim (12) of the infusion chamber (10) such that as the capsule holder (20) travels upwards to connect with the bottom rim (12) of the infusion chamber the lid (32) is pushed against a static opening member (40). The function of the member (40) is to create an opening in the lid which is defined by the pre-formed lines of weakness (34) in order to release liquid and tea material. This creates a flap which opens inwardly of the cavity (35) of the capsule. Preferably the lines of weakness are perforations so that the member (40) can be blunt, for example a wire.

In a preferred embodiment the member (40) is aligned in the radial direction of the capsule and is sized so as to correspond to the width (B) of the opening region in the radial direction. This shaped member together with the preferred embodiment of the perforations shown in FIG. 5(c) and described above results in an approximately elliptical opening in which the flap formed by the area of the lid which is opened is pushed back against the wall of the body part of the capsule, and is therefore held out of the way whilst the infusible material is released. Preferably the hinge part of the lid is situated just inside the capsule wall, so that the rim of the capsule acts as a pivot for the flap. Moreover, because the member (40) is aligned with the short axis (B) of the opening, it does not reduce the width of the opening, so does not restrict release of the larger tea particles. Thus the member can remain in place during release of the infusible material, which simplifies its construction. In contrast, if the member (40) were aligned along the long axis (A) of the opening, it would effectively halve the width of the opening, which could necessitate retracting it in order to allow the larger beverage material particles to be released.

In the preferred embodiment shown in FIG. 6, a second opening for introducing liquid into the capsule is made by pushing the lid (32) against a needle (42), preferably consisting of a tube with a pointed end. The needle can be made of any suitable material but is preferably made from plastic. The needle (42) is also mounted on the yoke (16) but is spaced away from the opening member (40) such that it pierces the lid (32) in a region away from the region opened by the opening member. Water is then pumped from the reservoir to the heater, which is preferably a flow-though heater. The resulting hot water (and optionally steam) is then pumped to the capsule and enters it through the needle. The influx of hot water pushes the infusible material out from the capsule through the opening made by the opening member (40) and into the infusion chamber (10).

In order to ensure efficient flow of water and infusible material out through the opening created by the opening member (40) it is preferred that the opening made by the opening member (40) provides less fluid resistance than the opening made by the needle (42). In this respect it is important that the needle (42) only pierces the lid (32) rather than creating any larger opening. In particular, in the embodiment of the capsule shown in FIG. 5(c) and which comprises two sets of lines of weakness (34) arranged symmetrically about the centre of the capsule lid (32), it is desirable that only one of the opening regions defined by the lines of weakness (34) is opened. In order that the opening regions may be conveniently opened by the device if aligned with the opening member but also resist opening when aligned with and pierced by the needle, the present inventors have found that the opening force as described herein is desirable.

The heater (56) and pump (54) are controlled so that the target brew temperature (which is typically in the range 80° C. to 95° C.) is achieved in the infusion chamber. Typically the water flow rate is in the range of 200 to 400 ml/min, and the volume of water is 150 to 300 ml, depending on the desired size of the beverage.

Preferably the infusion chamber (10) is made of transparent material such as glass, or transparent plastic, so that the user can see the motion of the infusible material (such as tea leaves) whilst the beverage is brewing. Most preferably, the infusion chamber is made of Tritan™ copolyester because this material is transparent and has been found to have good resistance to staining. Air may be pumped into the capsule holder (20) (e.g. via the needle) or directly into the infusion chamber (10) to create bubbles in the water and thereby agitate the infusible material. This not only enhances the visual appearance, but also aids infusion and helps to prevent the tea material from sticking to the sides of the infusion chamber. The brewing time, which typically ranges from 10 to 120 seconds, is preferably set by user input and/or information read from the capsule.

Once brewing has taken place for the required time, the passage (29) located in the base of the capsule holder (20) is opened, allowing the beverage to drain from the infusion chamber. Preferably the holder comprises a drain valve for opening and closing the passage, more preferably opening of the drain valve is controlled automatically by the device. The beverage flows from the infusion chamber through the filter (25) located in the capsule holder below the capsule, through the passage (29), and finally into a cup (9) which the user has already placed onto the tray (8). Spent infusible material is prevented from entering the cup (9) by the filter (25).

Optionally, there may be a dispensing spout (7) positioned beneath the capsule holder as shown in FIG. 1, so that the beverage is dispensed through the drain valve and out through the spout.

After the beverage has been dispensed, the spent tea material may be rinsed from the wall of the brew chamber with further hot water through the rinse head (18).

Finally, after the beverage has been dispensed, the capsule holder is lowered, preferably automatically, or alternatively by the user, for example by activating a button.

All numbers in this description indicating amounts of material, time periods, length scales, conditions of reaction, physical properties of materials and/or use may optionally be understood as modified by the word “about”. It should be noted that in specifying any range of values, any particular upper value can be associated with any particular lower value. For the avoidance of doubt, the word “comprising” is intended to mean “including” but not necessarily “consisting of” or “composed of”. In other words, the listed steps or options need not be exhaustive.

The disclosure of the invention as found herein is to be considered to cover all embodiments as found in the claims as being multiply dependent upon each other irrespective of the fact that claims may be found without multiple dependency or redundancy.

Where a feature is disclosed with respect to a particular aspect of the invention (for example a method of the invention), such disclosure is also to be considered to apply to any other aspect of the invention (for example a device of the invention) mutatis mutandis.

The various features of the embodiments of the present invention referred to in individual sections above apply, as appropriate, to other sections mutatis mutandis. Consequently features specified in one section may be combined with features specified in other sections as appropriate. Various modifications of the described modes for carrying out the invention which are apparent to those skilled in the relevant fields are intended to be within the scope of the following claims.

### Example

The following example demonstrates capsules with different opening forces.

### Capsules

Two sets of capsules were produced and filled with tea material. Set A was made according to the teaching of EP 2 781 174 A and Set 1 were made according to the present invention. The two sets were identical except for the cut:tie ratio of the perforations and were generally as shown and described in FIG. 5. The lid of each capsule was a film of an aluminium-HDPE laminate wherein the aluminium layer was 37 microns thick and the HDPE layer was 40 microns thick. The lines of weakness were formed by perforating both layers and had the configuration shown in FIG. 5. For Set A the cut:tie ratio of the perforations was 5.6:1 (3.37 mm cut and 0.6 mm tie). For Set 1 the cut:tie ratio was 2.3:1 (1.39 mm cut and 0.6 mm tie).

### Opening Force Measurement

The opening force of 20 of the opening regions of specimens of each Set was determined using the following procedure:

### Equipment and Materials

Zwick (Zwick Testing Machines Ltd, Leominster, UK) tensile/compression tester Z0.5 linked to Zwick testXpert software and fitted with a load cell of at least 20 N but preferably <200 N.
5 mm flat end cylindrical aluminum probe (Zwick part no. 324661).
Base plate and holder to hold and align the capsule being tested.

### Machine Parameters

| Pre-load | 1N | |
|---|---|---|
| Pre-load speed | 200 | mm/min |
| Test speed | 300 | mm/min |
| Force shutdown | 70% | Fmax |
| | (test stops when | |
| | force drops by 70% | |
| | of maximum force) | |
| Tool separation | 50 | mm |

### Method

Insert the probe into the top jaw.
Insert the capsule into the holder and onto the base plate.
Align the capsule so that an opening region is under the probe and the probe is positioned to enter the region in the centre of the opening region (i.e., at the intersection of the lines A and B in FIG. 5).
Position end of probe and capsule holder 50 mm apart.
Start the test with parameters listed above, apply a load until probe perforates the capsule.
Record the maximum force and calculate the average and standard deviation.

### Results

The opening regions of Set A had a mean opening force of 8.5 N with a 95% confidence interval of 0.3 N. The opening regions of Set 1 had a mean opening force of 11.0 N with a 95% confidence interval of 0.8 N.

### Capsule Performance

Capsules from Set A were found to be easily damaged during transport tests while those from Set 1 consistently survived transport and had opening regions that were easily opened by a blunt opening member but which were punctured without opening by a needle of a brewing device.

1. An automated capsule-based brewing machine comprising:
an infusion chamber;
a liquid supply for introducing liquid into the infusion chamber;
a device for introducing infusible beverage material into the infusion chamber;
an openable and closable passage for dispensing brewed beverage from the infusion chamber to a dispensing orifice; and
an automated control system for opening the passage to allow brewed beverage to flow under force of gravity from the infusion chamber, through the passage and to the orifice for a dispensing time, wherein the automated control system is configured to decrease the flow resistance of the passage during the dispensing time wherein the flow resistance is decreased from a high initial value at the start of the dispensing time and to a minimum value at the end of the dispensing time, the automated control system being further configured such that the flow resistance reduces gradually and/or in steps throughout substantially all of the dispensing time.

2. The machine as claimed in claim 1 wherein the control system is configured to provide that for at least a period of 1 second of the dispensing time the flow resistance is greater than the flow resistance at a later period in the dispensing time.

3. The machine as claimed in claim 2 wherein the control system comprises a valve and is configured to decrease the flow resistance by progressively opening the valve during the dispensing time.

4. The machine as claimed in claim 2 wherein the machine comprises a vessel located beneath the dispensing orifice.

5. The machine as claimed in claim 4 wherein the vessel is separated from the orifice by free space.

6. The machine as claimed in claim 4 wherein the vessel comprises an open spout.

7. The machine as claimed in claim 4 wherein the vessel is a tray with a base and a peripheral sidewall, the peripheral sidewall having a height of less than 3 cm.

8. The machine as claimed in claim 4 wherein the vessel is a plate.

9. The machine as claimed in claim 1 wherein the machine comprises a filter arranged to filter the beverage during dispensing, preferably arranged to allow beverage to flow through the filter prior to entering the passage.

10. The machine as claimed in claim 1 wherein the device for introducing infusible material into the infusion chamber comprises a capsule holder sized and shaped to receive a capsule.

11. The machine as claimed in claim 10 wherein the passage is located in the capsule holder, preferably in a base of the holder.

12. The machine as claimed claim 1 wherein the passage dispenses brewed beverage to a plurality of dispensing orifices.

13. A capsule-based brewing system comprising the machine as claimed claim 1 and a capsule containing infusible beverage material.

14. A method for preparing a beverage in an automated capsule-based brewing machine, wherein the method comprises the steps of:
a) introducing liquid and infusible beverage material into an infusion chamber of the machine so as to brew the beverage; and then
b) opening a passage in the machine for a dispensing time to allow the brewed beverage to flow under force of gravity from the infusion chamber to a dispensing orifice;
wherein in step (b) the flow resistance of the passage is decreased during the dispensing time wherein the flow resistance is decreased from a high initial value at the start of the dispensing time and to a minimum value at the end of the dispensing time, the flow resistance reducing gradually and/or in steps throughout substantially all of the dispensing time.

15. The method as claimed in claim 14 for preparing a beverage in the machine as claimed in claim 1.

16. Machine, system or method as claimed in claim 1 wherein the beverage is a tea beverage.
